(19) United States
(12) Patent Application Publication
(10) Pub. No.: US 2016/0318818 A1
(43) Pub. Date: Nov. 3, 2016

(54) CARBON DIOXIDE GAS TREATMENT SYSTEM

(71) Applicants: MING-HSIANG YANG, ZHUBEI CITY (TW); SHANG-SHAN FAN, TAICHUNG CITY (TW)

(72) Inventors: MING-HSIANG YANG, ZHUBEI CITY (TW); SHANG-SHAN FAN, TAICHUNG CITY (TW)

(21) Appl. No.: 14/754,311

(22) Filed: Jun. 29, 2015

(30) Foreign Application Priority Data
Apr. 30, 2015 (TW) 104113826
Apr. 30, 2015 (TW) 104206580

(51) Int. Cl. C05C 3/00; B01J 19/24

(52) U.S. Cl. CPC C05C 3/00; B01J 19/245; B01J 2219/24; B01J 2219/00087

(57) ABSTRACT

A carbon dioxide gas treatment system comprises: ammonia gas production device for providing ammonia gas; a waste gas treatment device, having a first washing column, a gas inlet, a first circulation water inlet, a first circulation water outlet, a first outlet and a second outlet, the carbon dioxide gas from the gas inlet may mix with ammonia gas to form a mixed gas before get into the first washing column and the mixed gas may mix with water from circulation water inlet in the first washing column to form solid ammonium bicarbonate and liquid ammonia; and a waste water treatment device, having a second washing column, a water inlet, a second circulation water inlet, a second circulation water outlet and a third outlet, the liquid ammonia get into the second washing column through the water inlet and mixed with water from second circulation water inlet to form ammonia gas.

### BACKGROUND OF THE INVENTION

1. Field of the Invention

The present invention relates to a carbon dioxide gas treatment system, and particularly to a carbon dioxide gas treatment system that can effectively convert carbon dioxide into solid ammonium carbonate salt to serve as nitrogen fertilizer without excess waste produced.

2. Description of the Prior Art

With the evolution of eras, people have continuously relied on fossil fuels to provide energy to supply daily necessities or industrial demands. However, the released greenhouse gas, such as carbon dioxide, has caused increasingly serious greenhouse effect, and the accompanied climate change has also become a global environmental problem. Thus, in addition to actually promoting energy saving, developing low-carbon energy and reducing carbon dioxide emissions, how to effectively treat or recycle carbon dioxide has become a main direction of the current research.

In general, the main recycling technologies of carbon dioxide can be sorted into the physical treatment method and the chemical treatment method. The physical treatment method, such as the physical absorption, physical adsorption, condensation at low temperature and membrane separation, etc., has to consume more energy, so that when carbon dioxide is needed to be recycled in large scale, it is not ideal in practice. Thus, the most commonly used method in industry is the chemical absorption method, in which the absorbent has chemical reaction with the carbon dioxide to achieve recycling the carbon dioxide and the absorbent is regenerated with the reverse reaction thereof. However, the solvent used in the chemical absorption method may have irreversible chemical reaction with other gas, which may affect the regeneration ability of the absorbent. Moreover, the absorbent may usually be an alkaline solvent, which may erode related equipments and pipes. Furthermore, additional chemical waste may be produced as well. To sum up the foregoing descriptions, provision of other effective recycling technology of carbon dioxide is needed.

### SUMMARY OF THE INVENTION

The present invention is directed to provide a carbon dioxide gas treatment system, which can effectively convert carbon dioxide into solid ammonium carbonate salt. The produced water and ammonia gas during the treatment process can be recycled for use, and nothing is squandered or no excess waste is produced, so that the recycling efficiency can be significantly improved and the effect of energy saving can be achieved.

One embodiment of the present invention provides a carbon dioxide gas treatment system, which comprises: an ammonia gas production device for producing ammonia gas; a waste gas treatment device comprising a first washing column, a gas inlet port, a first circulation water inlet port, a first circulation water outlet port, a first release port and a second release port, wherein the ammonia gas production device is connected with a front end of the gas inlet port, so that the carbon dioxide gas from the gas inlet port mixes with the ammonia gas to form a mixed gas before getting into the first washing column, and the mixed gas gets into the first washing column through the gas inlet port to be mixed with the water from the first circulation water inlet port to form solid ammonium carbonate salt and liquid ammonia, wherein the solid ammonium carbonate salt and the liquid ammonia are released through the first release port and the second release port respectively; and a waste water treatment device comprising a second washing column, a water inlet port, a second circulation water inlet port, a second circulation water outlet port and a third release port, wherein the liquid ammonia released through the second release port gets into the second washing column through the water inlet port to be mixed with the water from the second circulation water inlet port to form ammonia gas, wherein the ammonia gas is released through the third release port.

Preferably, the ammonia gas production device may further comprise: a liquid ammonia tank to store and supply liquid ammonia; and a gasification device to gasify the liquid ammonia supplied by the liquid ammonia tank to produce ammonia gas.

Preferably, the waste gas treatment device may further comprise a cooling circulation device, wherein the mixed gas mixed with water may be treated by the cooling circulation device to produce the solid ammonium carbonate slat and water.

Preferably, the water produced by the cooling circulation device may be released through the circulation water outlet port and recycled to the first washing column through the circulation water inlet port.

Preferably, the waste water treatment device may further comprise a heating device, wherein the liquid ammonia mixed with water may be treated by the heating device to produce the ammonia gas and water.

Preferably, the water produced by the heating device may be released through the circulation water outlet port and recycled to the second washing column through the circulation water inlet port.

Preferably, the third release port is connected with the gas inlet port by a pipe, and the ammonia gas produced by the heating device is transmitted to the gas inlet port through the pipe to be combined with the carbon dioxide gas and form the mixed gas.

Preferably, the solid ammonium carbonate salt may comprise ammonium bicarbonate (NH₄HCO₃).

The objectives, subject matters and properties of the present invention and the effects achieved by the present invention will become apparent from the following descriptions of the embodiments taken in conjunction with the accompanying drawings.

### BRIEF DESCRIPTION OF THE DRAWINGS

FIG. 1 is a schematic block diagram of a carbon dioxide gas treatment system according to the embodiment of the present invention.

### DESCRIPTION OF THE PREFERRED EMBODIMENT

The present invention will be described in more detail with the following preferred embodiments taken in conjunction with the accompanying drawings. It is noted that the details disclosed in the following embodiments are for convenience to explain the subject matters of the present invention, and it can never limit any aspects that can be embodied.

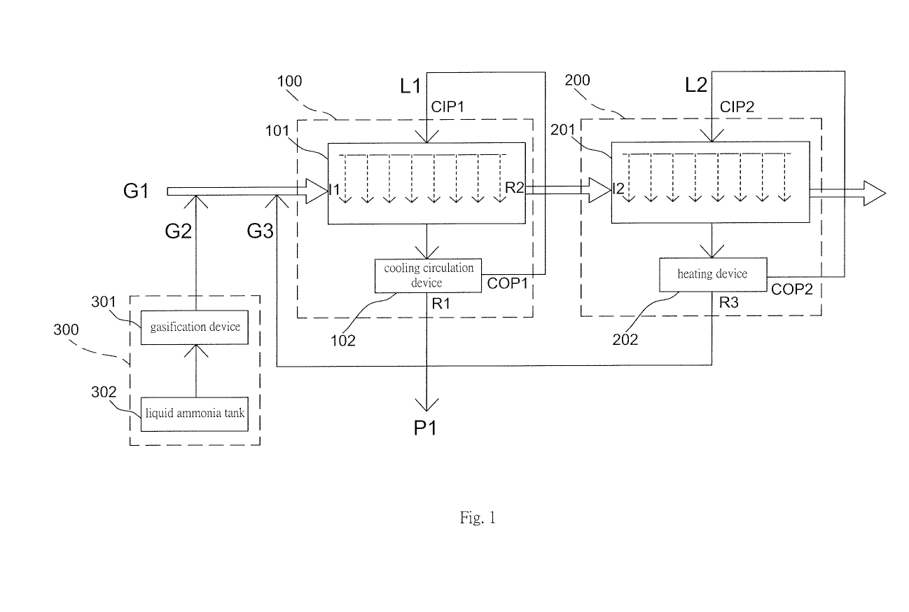

Referring to FIG. 1, a carbon dioxide gas treatment system according to the embodiment of the present invention comprises an ammonia gas production device 300, a waste gas treatment device 100 and a waste water treatment device 200. The ammonia gas production device 300 is used for producing ammonia gas G2. The ammonia gas production device 300 may comprise a liquid ammonia tank 302 and a gasification device 301. The liquid ammonia tank 302 may be used to store and supply liquid ammonia, and the gasification device 301 may be used to gasify the liquid ammonia supplied by the liquid ammonia tank to produce ammonia gas G2.

The waste gas treatment device 100 is equipped with a first washing column 101, a gas inlet port I1, a first circulation water inlet port CIP1, a first circulation water outlet port COP1, a first release port R1 and a second release port R2. The ammonia gas production device 300 may be connected with a front end of the gas inlet port I1 of the waste gas treatment device 100, so that the carbon dioxide gas G1 from the gas inlet port I1 mixes with the ammonia gas G2 to form a mixed gas before getting into the first washing column 101, and the mixed gas gets into the first washing column 101 through the gas inlet port I1 to be mixed with the water L1 from the first circulation water inlet port CIP1 to form solid ammonium carbonate salt P1 and liquid ammonia. The solid ammonium carbonate salt P1 and the liquid ammonia may be released through the first release port R1 and the second release port R2 respectively. Herein, the solid ammonium carbonate salt may comprise ammonium bicarbonate, which may be used as the raw material of nitrogen fertilizer and therefore may be recycled for agricultural uses.

The waste gas treatment device 100 further comprises a cooling circulation device 102. The mixed gas mixed with water may be treated by the cooling circulation device 102 to produce the solid ammonium carbonate salt P1 and water L1. The water produced by the cooling circulation device 102 is released through the first circulation water outlet port COP1 and recycled to the first washing column 101 through the first circulation water inlet port CIP1. With such configuration, the filtered-out water may be recycled and no additional washing water source is needed, so as to achieve the effects of saving energy and cost.

The waste water treatment device 200 comprises a second washing column 201, a water inlet port 12, a second circulation water inlet port CIP2, a second circulation water outlet port COP2 and a third release port R3. The liquid ammonia released through the second release port R2 of the waste gas treatment device 100 may get into the second washing column 201 through the water inlet port 12 of the waste water treatment device 200 to be mixed with the water from the second circulation water inlet port CIP2 to form ammonia gas, and the ammonia gas may be released through the third release port R3.

The waste water treatment device 200 may further comprise a heating device 202. The liquid ammonia mixed with water in the second washing column 201 may be treated by the heating device 202 to produce the ammonia gas G3 and water L2. Herein, the water L2 produced by the heating device 202 may be released through the second circulation water outlet port COP2 and recycled to the second washing column 201 through the second circulation water inlet port CIP. On the other hand, the ammonia gas G3 produced by the heating device 202 may be recycled to be combined with the carbon dioxide gas G1 to form the mixed gas. With the above-mentioned configuration, the filtered-out water and ammonia gas may be recycled, so that no energy or material is squandered and no additional chemical waste is produced, so as to significantly improve the effect of saving energy.

To sum up the foregoing descriptions, the carbon dioxide gas treatment system provided by the present invention uses the ammonia gas and water directly to effectively convert the carbon dioxide gas into the solid ammonium carbonate salt, which may be used as the raw material of nitrogen fertilizer. On the other hand, the produced liquid ammonia, ammonia gas and water during the treatment process can be recycled for use, and nothing is squandered or no excess waste is produced. Compared with the traditional chemical treatment method that needs to add additional chemicals to react with carbon dioxide, the carbon dioxide gas treatment system of the present invention can achieve the effects of being more environmentally friendly and saving energy.

What is claimed is:

1. A carbon dioxide gas treatment system, comprising:
an ammonia gas production device for producing ammonia gas;
a waste gas treatment device comprising a first washing column, a gas inlet port, a first circulation water inlet port, a first circulation water outlet port, a first release port and a second release port, wherein the ammonia gas production device is connected with a front end of the gas inlet port, so that the carbon dioxide gas from the gas inlet port mixes with the ammonia gas to form a mixed gas before getting into the first washing column, and the mixed gas gets into the first washing column through the gas inlet port to be mixed with the water from the first circulation water inlet port to form solid ammonium carbonate salt and liquid ammonia, wherein the solid ammonium carbonate salt and the liquid ammonia are released through the first release port and the second release port respectively; and
a waste water treatment device comprising a second washing column, a water inlet port, a second circulation water inlet port, a second circulation water outlet port and a third release port, wherein the liquid ammonia released through the second release port gets into the second washing column through the water inlet port to be mixed with the water from the second circulation water inlet port to form ammonia gas, wherein the ammonia gas is released through the third release port.

2. The carbon dioxide gas treatment system according to claim 1, wherein the ammonia gas production device further comprises:
a liquid ammonia tank to store and supply liquid ammonia; and
a gasification device to gasify the liquid ammonia supplied by the liquid ammonia tank to produce ammonia gas.

3. The carbon dioxide gas treatment system according to claim 1, wherein the waste gas treatment device further comprises a cooling circulation device, wherein the mixed gas mixed with water is treated by the cooling circulation device to produce the solid ammonium carbonate salt and water.

4. The carbon dioxide gas treatment system according to claim 3, wherein the water produced by the cooling circulation device is released through the first circulation water outlet port and recycled to the first washing column through the first circulation water inlet port.

5. The carbon dioxide gas treatment system according to claim 1, wherein the waste water treatment device further comprises a heating device, wherein the liquid ammonia mixed with water is treated by the heating device to produce the ammonia gas and water.

6. The carbon dioxide gas treatment system according to claim 5, wherein the water produced by the heating device is released through the second circulation water outlet port and recycled to the second washing column through the second circulation water inlet port.

7. The carbon dioxide gas treatment system according to claim 5, wherein the third release port is connected with the gas inlet port by a pipe, and the ammonia gas produced by the heating device is transmitted to the gas inlet port through the pipe to be combined with the carbon dioxide gas and form the mixed gas.

8. The carbon dioxide gas treatment system according to claim 1, wherein the solid ammonium carbonate salt comprises ammonium bicarbonate.
